(19) United States
(12) Patent Application Publication
(10) Pub. No.: US 2018/0349768 A1
(43) Pub. Date: Dec. 6, 2018

(54) CONFIGURING A NEURAL NETWORK BASED ON A DASHBOARD INTERFACE

(71) Applicant: CA, Inc., New York, NY (US)

(72) Inventors: Serge Mankovskii, Morgan Hill, CA (US); Steven L. Greenspan, Scotch Plains, NJ (US); Maria C. Velez-Rojas, San Jose, CA (US)

(21) Appl. No.: 15/614,928

(22) Filed: Jun. 6, 2017

(51) Int. Cl. G06N 3/08; G06F 3/0481; G06F 3/06

(52) U.S. Cl. CPC G06N 3/08; G06F 3/0602; G06F 3/0481

(57) ABSTRACT

Techniques are disclosed relating to configuring a neural network based on information received via a dashboard user interface. In some embodiments, a computing system displays a dashboard that includes a set of plots for displaying data and user interface elements that may be used to configure the number and type of the plots. The plots may display information of various kinds, including raw or processed data, relationships between data, processes applied to data, etc. and may be different types, including, e.g., spark lines, scatter, or time series, etc. The dashboard module is operable to communicate the user input to a module operable to generate a neural network topology. User input to the dashboard may provide information regarding sources of data to be used for generating plots, or training or running the neural network. Results based on processing data using the trained neural network may be displayed on the dashboard.

### BACKGROUND

### Technical Field

This disclosure relates generally to neural networks and more particularly to using a dashboard to configure the topology of a neural network.

### Description of the Related Art

Neural networks are a computing technique in which a network of nodes learns from a training data set. Neural networks are useful for various applications. Designing a neural network topology typically requires consideration of a skilled user. But, if designed to reflect the problem domain, a well-trained neural network can return high quality results. The personnel who would benefit from high quality neural networks, however, are rarely knowledgeable or skilled in their creation.

### SUMMARY

Techniques are disclosed relating to generating and training a neural network based on a dashboard user interface. In some embodiments, a computing system displays a dashboard, wherein the dashboard comprises a set of graphical plots and user interface elements that may be used to configure the number and type of the plots. The characteristics of plots may include the type of plot, the number of plots, the sequence of the plots, the relative sequence of plot types, the sizes of plots, what data and/or variables to use for the plots, raw or processed data, relationships between data, etc. In some embodiments, the computing system determines the characteristics of the plots based on user selections and displays a set of input graphical plots. In some embodiments, a neural network topology is generated based on the characteristics, discussed above, of the plots, as well as inputs used to configure the dashboard. User input to the dashboard may provide information regarding sources of data to be used for generating plots and/or training or running the neural network. The computing system may train the neural network with training data and subsequently process input data using the trained neural network. In some embodiments, results based on processing data using the trained neural network are displayed on the dashboard and an alert may be sent based on these results. These results may be a set of one or more output graphical plots.

Examples of inputs to the dashboard that may be used to configure the neural network topology include, without limitation: the number of plots, the type of plots, the relationships between data plotted, the order of plots as specified by the user, similarities represented by the plots, and/or the source of data used for the plots. In some embodiments, a layer in the neural network is generated for each plot. The user input may specify a sequence for the plots, and in some embodiments the sequence is used to configure the neural network topology. In some embodiments, a plurality of topologies are generated and a topology is selected according to at least one criterion. Non-limiting examples of criteria include the complexity of the topology, the performance of the topology, or the quality of results returned from the topology.

In some embodiments, results based on processing data using the trained neural network are displayed on the dashboard. The graphs created prior to training may be used to display the results and/or new graphs may be created to display these results. Results which may be displayed include but are not limited to the occurrence of an anomaly, relationships between data, classification of data, or predictions based on the data.

In some embodiments, an alert is sent based on results from processing data using the trained neural network. Non-limiting examples of alerts include a notification about an anomaly or a prediction. In some embodiments, the alert is a message sent to a user's mobile device.

In various embodiments, the disclosed techniques may advantageously provide neural network topologies that accurately reflect a problem domain without requiring a skilled user to design a topology. Rather, users that are relatively un-skilled in neural network technology may be able to develop dashboards and use an automatically-generated neural network topology (based on the dashboards as discussed above) to provide results.

### BRIEF DESCRIPTION OF THE DRAWINGS

FIG. 1 is a diagram illustrating an exemplary user interface dashboard, according to some embodiments.

FIG. 2 is a block diagram illustrating an exemplary system that is configured to generate a neural network topology based on a dashboard, according to some embodiments.

FIG. 3 is a flow diagram illustrating an exemplary method for generating a neural network based on a dashboard, according to some embodiments.

FIGS. 4A-4B are a flow diagrams illustrating exemplary methods for generating a neural network based on a dashboard, according to some embodiments.

FIG. 5 illustrates an overview of a neural network, according to some embodiments.

FIG. 6 is a block diagram illustrating an exemplary computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to generate a hash value” is intended to cover, for example, a mobile device that performs this function during operation, even if the device in question is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

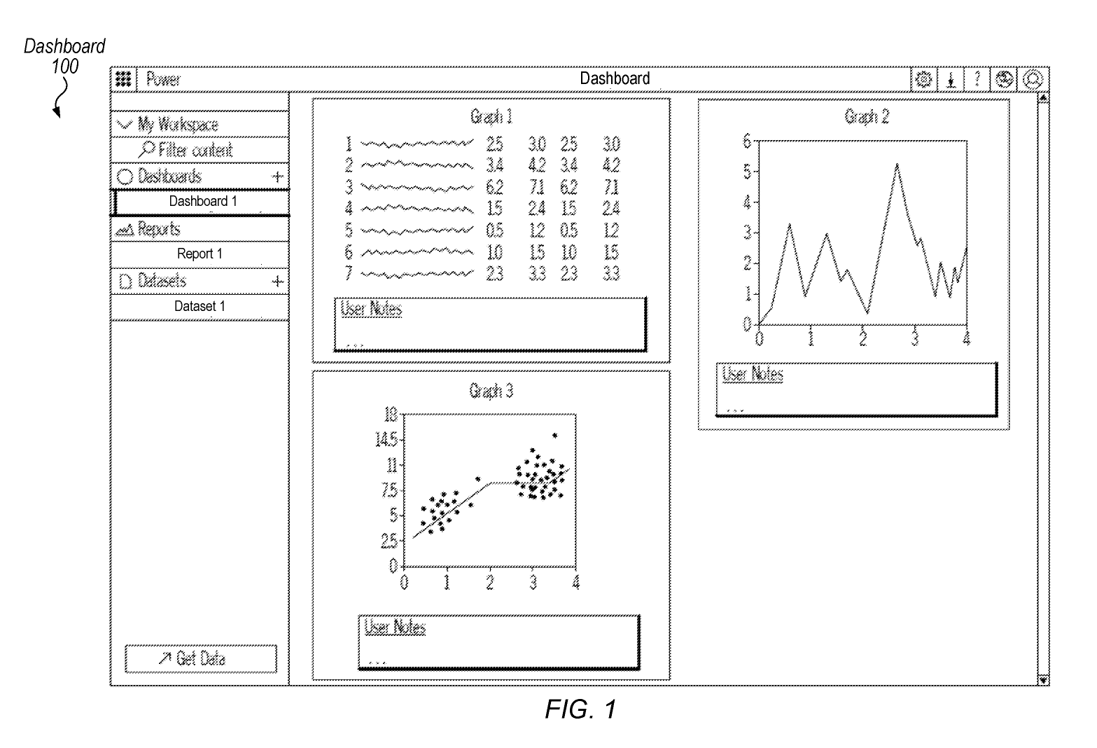

Techniques are disclosed relating to generating and training a neural network based on a dashboard user interface, such as the dashboard 100 shown in FIG. 1. In some embodiments, a computing system displays dashboard 100 wherein the dashboard comprises a set of plots and user interface elements that may be used to configure the number and type of the plots. The characteristics of plots may include the type of plot (including, e.g., spark lines, scatter, or time series, etc. An explanation of exemplary plot types is provided below), the number of plots, the sequence of the plots, the relative sequence of plot types, the sizes of plots, what data and/or variables to use for the plots, raw or processed data, relationships between data, etc. In some embodiments, the computing system determines the characteristics of the plots based on user selections and displays a set of input graphical plots. In some embodiments, a neural network topology is generated based on the characteristics, discussed above, of the plots, as well as inputs used to configure the dashboard. User input to the dashboard may provide information regarding sources of data to be used for generating plots and/or training or running the neural network. The computing system may train the neural network with training data and subsequently process input data using the trained neural network. In some embodiments, results based on processing data using the trained neural network are displayed on the dashboard and an alert may be sent based on these results. These results may be a set of one or more output graphical plots.

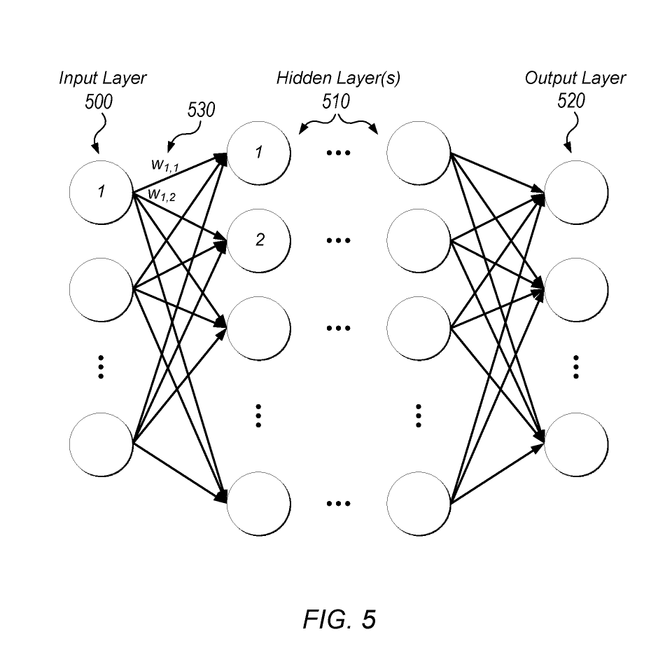

The term “neural network” is intended to be construed according to its well-understood meaning in the art, which includes data specifying a computational model that uses a number of nodes, where the nodes exchange information according to a set of parameters and functions. Each node is typically connected to many other nodes, and links between nodes may be enforcing or inhibitory in their effect on the activation of connected nodes. The nodes may be connected to each other in various ways; one example is a set of layers where each node in a layer sends information to all the nodes in the next layer (although in some layered models, a node may send information to only a subset of the nodes in the next layer). A more detailed overview of neural networks is provided below with reference to FIG. 5.

In some embodiments, at least a portion of the topology of the neural network is generated based on inputs used to configure the dashboard 100. As used herein, a “topology” of a neural network is intended to be construed according to its well-understood meaning in the art, which includes, but is not limited to, data specifying the manner in which nodes in the neural network are interconnected, the number of layers in the neural network, and the configuration of input and output nodes. Note that a given neural network topology may be trained to use different weights and may process different input data sets while still maintaining the same topology.

As used herein, “generating” a topology of a neural network is intended to be construed according to its well-understood meaning in the art, which includes, but is not limited to, creating data related to the topology of the neural network, where the data may specify the characteristics of the topology as discussed above. In some embodiments, this data is stored or transmitted to another computer system or module.

As used herein, “generating” a neural network is intended to be construed according to its well-understood meaning in the art, which includes, but is not limited to initializing a set of data structures in the memory of a computing system, specifying interactions between parts of data structures, and configuring a computing system to provide data for the neural network. The generated neural network may be implemented entirely in software or may be partially or entirely implemented as hardware. In some embodiments, generating the neural network includes configuring a hardware device to perform the functions of a neural network.

FIG. 1 shows an exemplary dashboard 100 according to some embodiments. The dashboard 100 may include multiple plots; the illustrated example includes three plots, Graph 1, a spark line plot, Graph 2, a time series plot, and Graph 3, a scatter plot. A sparkline plot is a type of line plot that illustrates the general shape of a variation, usually over time, of one or more values. Some embodiments of a sparkline plot will include multiple lines and a set of numbers related to each line. Display of stock quotes is one well-known use of a sparkline plot. A time series plot is a type of plot that illustrates data over a time period (note that a sparkline plot is one example of a time series plot). Time series plots may be presented as line plots, and may include multiple series of data in one plot space. A scatter plot is a type of plot that illustrates relationships between variables in a data set. In some embodiments, different variables are plotted on different axes. Scatter plots may be comprised of points and/or lines, and may include one or more lines that describe the relationship of the data. Lines need not be straight; various non-straight lines, including without limitation, quadratic, exponential, lines drawn only as a guide to the eye, etc. may be included on a scatter plot. The lines may be an approximation based on points in the scatter plots, for example.

In some embodiments, dashboard 100 has default plots which may be displayed prior to any user input. These default plots may be implemented in multiple ways; they may display data from a set of exemplary data, they may be set up as specific types of plots but display no data, they may include some combination of plots with and without data and/or types, etc. In some embodiments, subsequent to the user providing a data source, a set of default plots may be displayed based on the data source. Several types of plots, multiple plots of similar types, or a single plot may be displayed. Data for default plots may be selected according to various criteria, including: amount of data, number of variables, labels on data, etc.

The dashboard 100 also includes examples of elements for user input, which include a field for user notes and inputs for datasets. In some embodiments, the characteristics of the plots are determined based at least in part on user inputs to the input elements. Non-limiting characteristics may include the type of plot, the number of plots, the sequence of the plots, the relative sequence of plot types, the sizes of plots, what data and/or variables to use for the plots, etc. In some embodiments, there may be multiple workspaces of dashboards accessible via the dashboard 100. Additionally, FIG. 1 shows an exemplary space for reports which may be used for various purposes, including displaying results from processing data using the trained neural network, displaying alerts, or displaying additional relationships in the data. Additional user interface elements and/or interactions (e.g., such as drag and drop functionality) that are not explicitly shown may be used, by a user, to specify input for any of various the techniques discussed herein.

In some embodiments, the characteristics of plots shown in dashboard 100 are determined and used to generate a topology for a neural network. Thus, rather than worrying about neural network topologies, a user may be able to simply configure dashboard 100 to a desired configuration and then use an automatically-generated neural network topology to process the data. The characteristics may include the characteristics of the plots, the datasets, the configuration of the user input elements, etc. In some embodiments, the determined characteristics that are used are the plot characteristics described above, e.g. the type of plot, the number of plots, the sequence of the plots, etc. In some embodiments, default values from the dashboard may dictate some of the determined characteristics. The determined characteristics may be sent to another computing system or to another component of the computing system of the dashboard. In some embodiments, the computing device that executes the module that displays dashboard 100 may also generate the neural network topology, using the same module or another module. In other embodiments, other computing devices may generate the topology based on the characteristics.

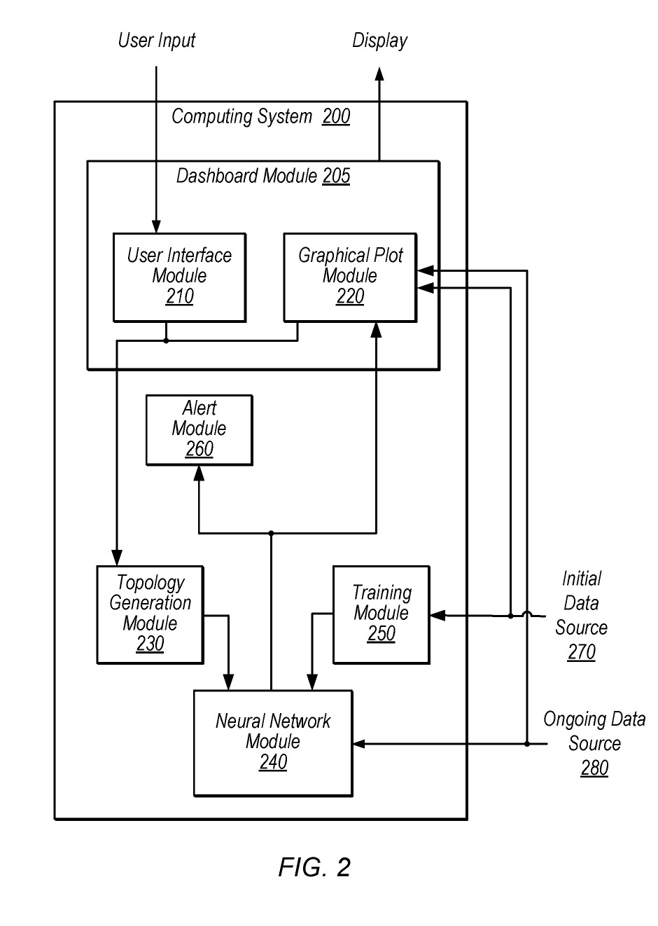

FIG. 2 is a block diagram illustrating an exemplary computing system 200 configured to generate a neural network topology based on information received via a dashboard such as dashboard 100 shown in FIG. 1. In the illustrated embodiment, system 200 includes various modules configured to perform designated functions discussed in more detail below.

As used herein, the term “module” refers to circuitry configured to perform specified operations or to physical non-transitory computer readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

As shown, in one embodiment computing system 200 includes various modules. These modules include dashboard module 205, which further includes, in one embodiment, user interface module 210 and graphical plot module 220. Computing system 200 further includes alert module 260, topology generation module 230, training module 250, and neural network module 240, in the illustrated embodiment.

Dashboard module 205, in some embodiments, is configured to maintain information for a dashboard interface, receive user input configuring the dashboard interface, and generate various plots for the graphical interface. In some embodiment, graphical plot module 220 is configured to display various plots of the interface, which may be default plots and/or may be based on user input received via user interface module 210. In the illustrated embodiment, dashboard module 205 is configured to provide dashboard characteristics to topology generation module 230, which may generate a neural network topology based on the characteristics.

A user configures dashboard module 205 in the illustrated embodiment, via user input to user interface module 210. This may include specifying an ordering of the plots, types of data to be plotted in different plots, types of plots, a number of plots, etc. In addition to information about the graphical plots, the user interface 210 may include inputs to select data sources, subsets of data sources, sets of variables to be used from data sources, etc.

In some embodiments, graphical plot module 220 is configured to display graphical plots of input data sources and/or processed data from neural network module 240. The graphs created prior to training may be used to display the results or new graphs may be created to display these results. Results which may be displayed include, without limitation, the occurrence of an anomaly, relationships between data, classification of data, or predictions based on the data.

Topology generation module 230, in the illustrated embodiment, is configured to generate a neural network topology based on dashboard characteristics maintained by dashboard module 205. In some embodiments, neural network module 240 maintains a neural network that exhibits the generated topology. In some embodiments, neural network module 240 includes a set of data specifying characteristics of a neural network, e.g. the topology of the neural network, a set of data specifying the current state of the neural network, etc. In some embodiments, neural network module 240 is configured to process input data and produce output data.

In the illustrated embodiment, initial data source 270 supplies data to training module 250. Training module 250, in some embodiments, is configured to train the neural network maintained by neural network training module 240 using the input data. The term “training” a neural network, as used herein, is intended to be construed according to its well-understood meaning in the art, which includes, but is not limited to processing data with a neural network, determining a difference between output data and labeled data, and adjusting the parameters of the neural network based on the difference. In some embodiments, training a neural network may proceed without comparison against labeled data. The method used for training a neural network may be specified as one of the characteristics of the neural network or it may be specified as a characteristic of the neural network training module.

In some embodiments, system 200 is configured to train neural network module 240 (which exhibits the generated topology) on the data which has been specified through the dashboard module 205. System 200 may also train neural network module 240 on data acquired through means other than user input to the dashboard module 205. In some embodiments, the neural network has multiple hidden layers; in these embodiments, the layers may be at least partially trained individually. Additional training may be performed on the entire neural network module 240 or on sets of the individual layers, or no additional training may be performed. In some embodiments, system 200 is configured to acquire multiple different sets of data, at the same or different times. Data may be acquired continually or at regular or irregular intervals, and training may occur as new data is acquired or at regular or irregular intervals. Acquired data may be used for training, processing, or any combination of the two.

In the illustrated embodiment, once the neural network is trained, the neural network module 240 is configured to send results to the dashboard module 205 so the results may be processed and/or displayed using graphical plot module 220. Neural network module 240 may also send results to alert module 260 so that alerts may be sent to the user. One non-limiting example of alerts is a notification about an anomaly or a prediction. Alerts may be sent using dashboard module 205, the graphical plot module 220, the user interface 210, or in some other manner, including but not limited to text message, email, etc. In some embodiments, an ongoing data source 280 is connected to the neural network to supply data in an ongoing manner. Results from neural network module 240 based on ongoing data 280 may be sent to the alert module 260 and/or the dashboard module 205 in the same manner as described above.

In some embodiments, ongoing data source 280 provides multiple sets of input data for processing at different points in time. In some embodiments, ongoing data source 280 provides input data in real time. In other embodiments, ongoing data source 280 may provide input data periodically or in batches based on some trigger parameter.

In some embodiments, system 200 is an end-user computing system. In these embodiments, the components of system 200 may all be stored on one or more memories and executed by one or more processors of the end-user computing system. In other embodiments, the computing system 200 may include server and client computing systems. In these embodiments, a subset of the modules of system 200 may be accessed by the client from the server, using a network. Information may be transmitted over the network may include, e.g. the neural network characteristics, the neural network topology, training data, results, etc. In some embodiments system 200 may be entirely a server computing system. In these embodiments, a user may access dashboard module 205 directly from the server or through an interface (e.g. a web browser, terminal, etc.). Therefore, various modules of FIG. 2 may be implemented by the same circuitry (e.g., the same processor(s) and memory) or by different circuitry, where the different circuitry may reside on the same device or on different devices.

Examples of inputs to the dashboard module 205 that may be used to alter the dashboard (and thus potentially affect configuration of a neural network topology that is generated based on the dashboard) include the number of plots, the type of plots, the relationships between data plotted, the order of plots as specified by the user, similarities represented by the plots, the source of data used for the plots, etc. In some embodiments, system 200 is configured to generate a layer in the neural network for each plot. For example, for dashboard 100 of FIG. 1, three hidden layers may be generated, one for each plot. The user input may specify a sequence ordering for the plots, and in some embodiments the sequence is used to configure the neural network topology (e.g., by ordering layers in the neural network to correspond to the specified sequence of plots).

In some embodiments, user input to the dashboard module 205 provides information regarding data to be used for generating plots and/or training or running the neural network. For example, the user input may identify data source 270. System 200 may retrieve data from a data source or from one or more storage elements included in system 200, e.g. a database or a storage drive. In some embodiments, user input provides access to a data source through a network and/or to a data source which may be secured or encrypted. User input may provide security keys or passwords for accessing encrypted or secured data.

In some embodiments, relationships between data are displayed by graphical plots with graphical plot module 220. The relationships may include whether some variables are included in multiple plots, the degree of correlation exhibited by some subsets of variables, the frequency of occurrence of similar values between different variables, the range of variables, the number of observations of variables, etc. In some embodiments, the same relationships that are plotted and/or other relationships are used to configure the neural network topology. Non-limiting examples of additional relationships that may or may not be plotted include the appearance of common axes between plots, a transitive relation between plot axes, etc. Data relationships may be used in various ways to generate a topology, for example, the occurrence of a similar variable in certain axes of plots may be used to infer an ordering of the hidden layers, the number of variables plotted on a single axis may be used to infer the number of nodes in a layer, similarities between the variables on multiple plots may be used to create a single hidden layer to represent multiple plots, multiple types of variables in a plot may be used to generate multiple layers based on a single plot, etc.

In some embodiments, system 200 is configured to generate multiple topologies and select one of the generated topologies according to at least one criterion. Non-limiting examples of criteria include metrics for: the complexity of the topology, the performance of the topology, or the quality of results returned from the topology. For example, system 200 may be configured to generate topologies with different orderings of layers (where ones of the layers correspond to graphical plots in dashboard module 205). System 200 may then be configured to perform training on the different topologies and determine which topology provides the best training results. A metric for quality of training results may be determined based on comparing results with an independent data set and/or cross validation, for example. As other examples, system 200 may be configured to select the topology with the least complexity, highest estimated performance, some combination of multiple parameters, etc. A metric for complexity of a topology may be determined in many ways, including but not limited to: the number of layers, the number of nodes, the number of connections between nodes, etc. A metric for performance may also be determined in many ways, including but not limited to: the speed with which the neural network may be trained, the amount of computational resources required to process input data, etc. In some embodiments, a metric for performance may also be determined based on the quality of training results discussed above, the quality of results based on comparing processed results to another set of results, etc.

### Exemplary Embodiment

In one exemplary embodiment, the user inputs parameters to the dashboard that indicate a specific use case, e.g. anomaly detection, using a template that defines a number of graphical plots. In this example, the user may define plots that, in the following sequence, indicate: the number of currently active virtual machine (VM) images within a dynamically provisioned elastic computing system, network traffic monitoring data reflecting data movement between the VM images, the number of transactions flowing through the overall system, and the number of database errors emitted by a backend storage system.

Continuing this example, the resulting neural network generated by the system could include an input layer that receives a command from the dashboard to search for evidence of a specific type of anomaly. The number of inputs in the input layer may be in direct proportion to the number of specific types of anomaly detection considered by the user. For example, the input layer might represent a Boolean combination of conditions that need to be detected. In this embodiment, the conditions encode conditions that may include Service Level Agreement (SLA) constraints (e.g. resource performance SLA, network reliability SLA, overall processing time SLA, etc.).

In this embodiment, activation of a specific output corresponds to detecting a condition specified at the input layer, e.g. a specific type of anomaly. On detecting an anomaly, the output layer of the neural network may trigger the system to send an alarm, where the alarm may trigger a procedure that draws the user's attention to a specific output on the output layer. In some embodiments, the number of output layer nodes is equal or greater than the number of input layer conditions. The number of input layer nodes and output layer nodes may be equal when the encoded conditions have only two levels and the number of input layer nodes may be greater if at least one encoded condition has more than one state, e.g. a condition may have state “normal,” “slightly abnormal,” “severe,” etc.

In the embodiment under discussion, hidden layers in the neural network correspond to the number and sequence of plots depicted on the dashboard. In some embodiments, a hidden layer is generated for each plot. In this embodiment, there are four layers, in the following sequence: resource reliability SLA in hidden layer 1, network reliability SLA in hidden layer 2, number of transactions SLA in hidden layer 3, number of database errors SLA in hidden layer 4. Each layer may be associated with a training data source containing historic data. In this embodiment, training of the neural network is done by training the layers individually in sequence, using the output of the previous later. Results of the training may be evaluated against prior detected conditions or the results may have to be evaluated and labeled by the user. In this embodiment, once the neural network has been trained to the satisfaction of the user, the system may switch input from an historical data source to an ongoing data source.

In this embodiment, the dashboard may display ongoing data on the graphical plots. When an output node indicates an anomaly detection, the dashboard may indicate the anomaly by annotating the time series in some way, e.g. by coloring the graphs into a predefined color, and/or executing an alarming process, etc.

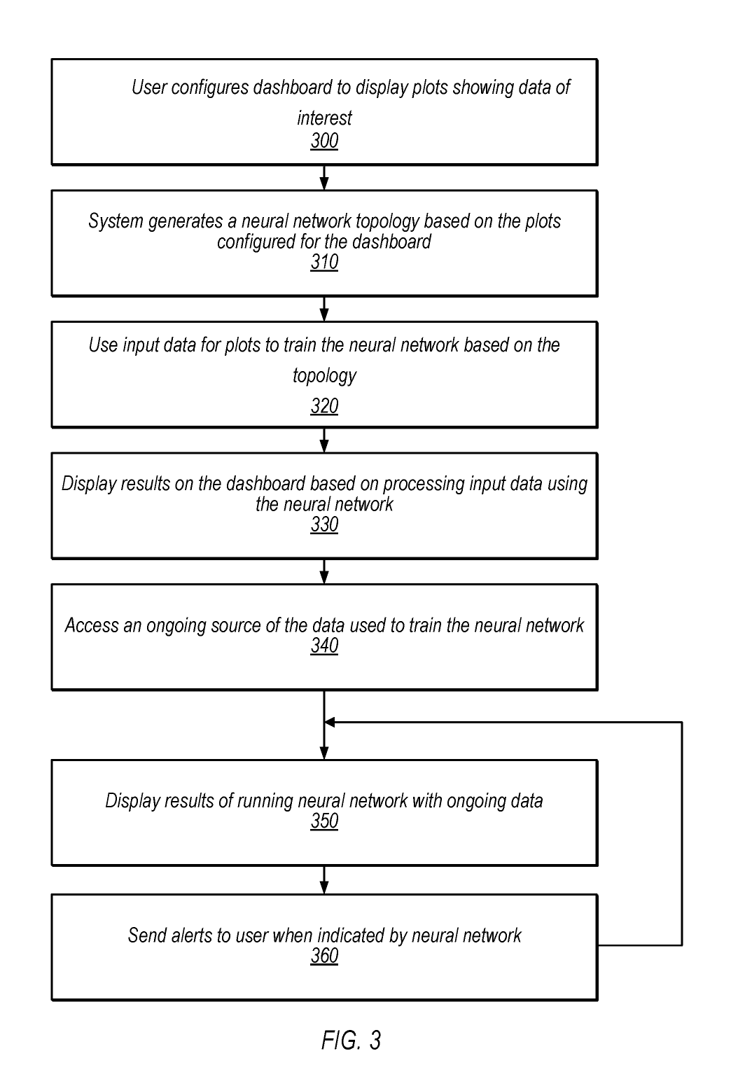

FIG. 3 is a flow diagram illustrating a method for configuring a neural network based on a dashboard interface, according to some embodiments. The method shown in FIG. 3 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 300 in the illustrated embodiment, a user configures the dashboard interface to display plots showing data of interest. The data used for this may be acquired from a user specified source (e.g., a spreadsheet, a database, etc.). In some embodiments, the user may specify various numbers and types of plots in various sequences.

At 310 in the illustrated embodiment, system 200 generates a neural network topology based on the plots configured for the dashboard. The topology may include a layer in the neural network for each plot, and the layers may be ordered according to a sequence of plots specified by the user. The sequence of plots specified by the user may be, but is not limited to, the order in which the user created the plots. In some embodiments, system 200 may imply sequencing of at least a portion of the plots without explicit user input specifying the sequence.

At 320 in the illustrated embodiment, system 200 uses the data used for plots to train the neural network based on the generated neural network topology. Training may be performed using the entire set of data or part of the data. Training may also be performed using data that was not used for the plots.

At 330 in the illustrated embodiment, the trained neural network processes data and dashboard module 205 displays the results. The dashboard module 205 may display the results using graphical plots with graphical plot module 220, including the user-specified plots. The results may be based on training data or may be based on other input data that is not used for training (e.g., after training is completed).

At 340 in the illustrated embodiment, system 200 accesses an ongoing source of data and trains the neural network using that data. Ongoing data may be accessed at regular or irregular time intervals. The ongoing data may also be the same source as the training data or may be from a different source.

At 350 in the illustrated embodiment, the trained neural network processes the ongoing data and displays the results from the processing. The dashboard module 205 may display the results using one or more plots, including the user-specified plots. Results may be plotted using the same input graphical plots or may be plotted on a new set of output graphical plots. The types of the output graphical plots may be the same or different compared to the input graphical plots. In some embodiments, some results will be displayed on the existing input graphical plots and some results will be displayed on a different set of output graphical plots. In some embodiments, the output graphical plots include a set of plots where some of the plot types are different.

At 360 in the illustrated embodiment, system 200 sends alerts to the user based on the results from processing done by the neural network module 240. The dashboard module 205 may display the alerts, using methods including displaying messages and/or plots. Alerts may be sent to the user as messages to a mobile device.

In the illustrated embodiment elements 350 and 360 are performed in an ongoing fashion such that flow returns to element 350 after element 360. Ongoing data may be regularly or irregularly processed by the neural network module 240 with dashboard module 205 displaying the data and/or results using graphical plot module 220. Alerts may then be sent to the user as discussed previously. In some embodiments, system 200 may also be configured to perform other method elements multiple times, e.g., to re-train the neural network, adjust the topology based on changes to the dashboard, etc.

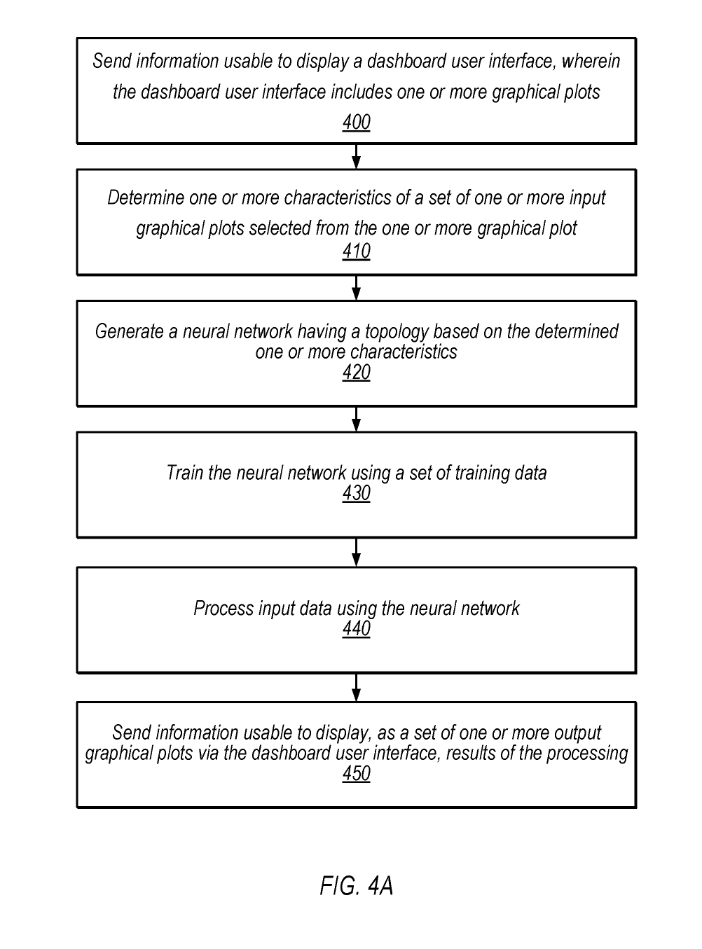

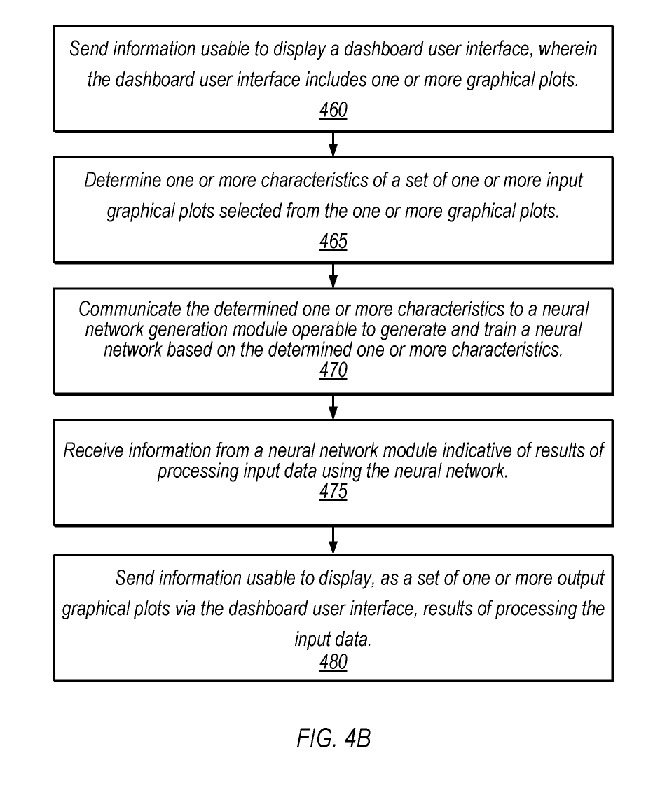

FIG. 4A is a flow diagram illustrating a method for configuring a neural network based on a dashboard, according to some embodiments. The method shown in FIG. 4A may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 400 in the illustrated embodiment, system 200 sends information usable to display a dashboard user interface comprising a set of one or more graphical plots. Dashboard module 205 may be configured to generate user interface elements and/or graphical plots. In some embodiments, system 200 may send information to a display device of an end-user system.

At 410 in the illustrated embodiment, system 200 determines one or more characteristics of at least one of the graphical plots. Non-limiting examples of characteristics include types of plots, number of plots, data sources for plots, etc. In some embodiments, user input is used to determine the characteristics. In other embodiments, default characteristics are used, or characteristics are determined automatically.

At 420 in the illustrated embodiment, system 200 generates a neural network having a topology based on the determined one or more characteristics. Generating a neural network may be done in several ways, including but not limited to generating many neural networks and selecting one according to some criteria.

At 430 in the illustrated embodiment, system 200 trains a neural network using a set of training data. Training may be performed by training module 250 using initial source data 270. In some embodiments, default data may be used, or training may not be performed.

At 440 in the illustrated embodiment, system 200 processes input data using the neural network. Processing may include running the neural network on data used for training or may include running the neural network on ongoing data. Results from the processing may be stored on a computer readable memory or may be output.

At 450 in the illustrated embodiment, system 200 displays, using one or more graphical plots of the dashboard module 205, results of the processing. Display may be performed using user specified graphical plots. In some embodiments, additional graphical plots are generated to display results.

FIG. 4B is a flow diagram illustrating another method for configuring a neural network based on a dashboard, according to some embodiments. The method shown in FIG. 4B may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 460 in the illustrated embodiment, system 200 sends information to display a dashboard user interface comprising a set of one or more graphical plots. The dashboard interface may contain user interface elements and/or graphical plots. In some embodiments, system 200 is an end-user computing system that sends information to a display device. In some embodiments, system 200 may be a server computing system which sends the information to a client computer system or an end-user computing system.

At 465 in the illustrated embodiment, system 200 determines one or more characteristics of a set of one or more input graphical plots selected from the one or more graphical plots. In some embodiments, user input is used to determine the characteristics. In other embodiments, default characteristics are used, or characteristics are determined automatically. In some embodiments, system 200 is an end-user system.

At 470 in the illustrated embodiment, system 200 communicates the determined one or more characteristics to a neural network generation module operable to generate and train a neural network based on the determined one or more characteristics. In some embodiments, system 200 is an end-user system that communicates with a server computing system which may maintain the neural network generation module 240.

At 475 in the illustrated embodiment, system 200 receives information from a neural network module indicative of results of processing input data using the neural network. In some embodiments, processing is performed on a server computing system and results are sent to system 200.

At 480 in the illustrated embodiment, system 200 sends information usable to display, as a set of one or more output graphical plots via the dashboard user interface, results of processing the input data. Processing may include running the neural network on data used for training or may include running the neural network on ongoing data. In some embodiments, processing may be done on a server computing system and sent to system 200. In other embodiments, processing may be done via a module of system 200 and the information sent to a display device.

In various embodiments, the disclosed techniques may advantageously provide neural network topologies that accurately reflect a problem domain without requiring a skilled user to design a topology. Rather, users that are relatively un-skilled in neural network technology may be able to develop dashboards and use an automatically-generated neural network topology (based on the dashboards as discussed above) to provide results.

### Neural Network Overview

FIG. 5 shows a neural network, a computing structure commonly known in the art. A neural network may be implemented in hardware, (e.g. as a network of processing elements) in software, (e.g. as a simulated network) or otherwise in some embodiments. A neural network is comprised of a set of nodes which receive inputs, process those inputs, and send outputs. In some embodiments, the processing involves combining the received inputs according to a set of weights 530 which the node maintains, and then using that result with an activation function to determine what value to output. A complete neural network may be made up of an Input Layer 500, and Output Layer 520, and one or more Hidden Layers 510. The nodes in the Input Layer 500 and Output Layer 520 present a special case; the input nodes send input values to the nodes in the Hidden Layer(s) and do not perform calculations on those values and the nodes of the Output Layer do not pass along values.

Combining and processing input signals to produce an output can be done in various ways which will be familiar to someone skilled in the art. One embodiment involves summing the product of the input value and the respective weight 530 for each node that sends input. This value is then input to an activation function which returns a value to send as output to the next node. In some embodiments, possible activation functions include a sigmoid function or a hyperbolic tangent.

A neural network may be configured to have a variety of connection structures. In some embodiments, as shown in FIG. 5, each node may connect to all of the nodes in the next layer, where “next” indicates towards the right in FIG. 5, and is defined by the direction from input to output. Neural networks may be configured to have an arbitrary number of Hidden Layers, and all layers, including Input and Output Layers, may have an arbitrary number of nodes, as indicated by the ellipses in FIG. 5. In some embodiments, neural networks may have some connections which send information to previous layers or connections which skip layers.

Neural networks can be configured to learn by processing training data. In some embodiments, training data is data which has been labeled so that the output of the neural network can be compared to the labels. Learning may be accomplished by minimizing a cost function which represents the difference between the labeled results and the neural network outputs; one example is the least squares method. In order to improve results, the connections weights may be changed. One embodiment of this method is referred to as backpropagation; this method involves computing an error term for each connection, moving from the output to the input. Other learning methods will be known to a person skilled in the art.

The output of a neural network may be determined by the number of layers and nodes of the neural network, the connection structure, the set of weights, and the activation functions. Due to the ability of neural networks to learn, uses for them include classification, regression, and data processing, among others.

### Exemplary Device

In some embodiments, any of various operations discussed herein may be performed by executing program instructions stored on a non-transitory computer readable medium. In these embodiments, the non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

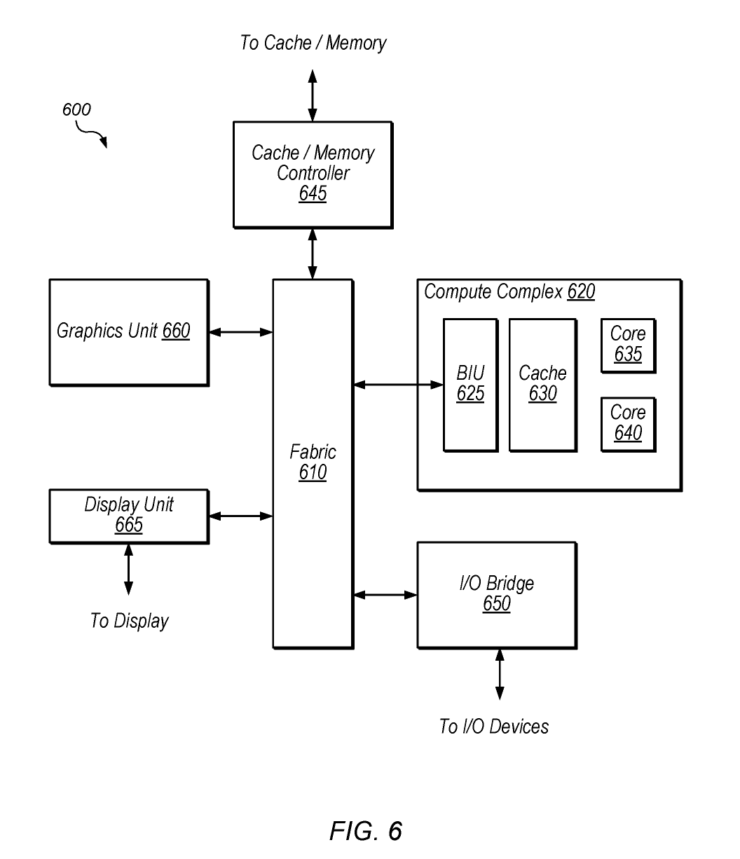

Referring now to FIG. 6, a block diagram illustrating an exemplary embodiment of a device 600 is shown. The illustrated processing elements may be used to implement all or a portion of system 200, in some embodiments. In some embodiments, elements of device 600 may be included within a system on a chip. In the illustrated embodiment, device 600 includes fabric 610, compute complex 620, input/output (I/O) bridge 650, cache/memory controller 645, graphics unit 660, and display unit 665.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores and/or caches.

For example, compute complex 620 may include 1, 2, or 4 processor cores, or any other suitable number. In one embodiment, cache 630 is a set associative L2 cache. In some embodiments, cores 635 and/or 640 may include internal instruction and/or data caches. In some embodiments, a coherency unit (not shown) in fabric 610, cache 630, or elsewhere in device 600 may be configured to maintain coherency between various caches of device 600. BIU 625 may be configured to manage communication between compute complex 620 and other elements of device 600. Processor cores such as cores 635 and 640 may be configured to execute instructions of a particular instruction set architecture (ISA) which may include operating system instructions and user application instructions.

Cache/memory controller 645 may be configured to manage transfer of data between fabric 610 and one or more caches and/or memories. For example, cache/memory controller 645 may be coupled to an L3 cache, which may in turn be coupled to a system memory. In other embodiments, cache/memory controller 645 may be directly coupled to a memory. In some embodiments, cache/memory controller 645 may include one or more internal caches.

As used herein, the term “coupled to” may indicate one or more connections between elements, and a coupling may include intervening elements. For example, in FIG. 6, graphics unit 660 may be described as “coupled to” a memory through fabric 610 and cache/memory controller 645. In contrast, in the illustrated embodiment of FIG. 6, graphics unit 660 is “directly coupled” to fabric 610 because there are no intervening elements.

Graphics unit 680 may include one or more processors and/or one or more graphics processing units (GPU's). Graphics unit 680 may receive graphics-oriented instructions, such as OPENGL® or DIRECT3D® instructions, for example. Graphics unit 680 may execute specialized GPU instructions or perform other operations based on the received graphics-oriented instructions. Graphics unit 680 may generally be configured to process large blocks of data in parallel and may build images in a frame buffer for output to a display. Graphics unit 680 may include transform, lighting, triangle, and/or rendering engines in one or more graphics processing pipelines. Graphics unit 680 may output pixel information for display images.

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement: universal serial bus (USB) communications, security, audio, and/or low-power always-on functionality, for example. I/O bridge 650 may also include interfaces such as pulse-width modulation (PWM), general-purpose input/output (GPIO), serial peripheral interface (SPI), and/or inter-integrated circuit (I2C), for example. Various types of peripherals and devices may be coupled to device 600 via I/O bridge 650.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer-readable storage medium having instructions stored thereon that are executable by a computing system to perform operations comprising:
sending information usable to display a dashboard user interface, wherein the dashboard user interface includes one or more graphical plots;
determining one or more characteristics of a set of one or more input graphical plots selected from the one or more graphical plots;
generating a neural network having a topology based on the determined one or more characteristics;
training the neural network using a set of training data;
subsequently processing input data using the neural network; and
sending information usable to display, as a set of one or more output graphical plots via the dashboard user interface, results of processing the input data.

2. The medium of claim 1, wherein the instructions are executable by the computing system to send information usable to display the one or more input graphical plots as default graphical plot types without data.

3. The medium of claim 1, wherein, in response to two or more input graphical plots being selected, the instructions are executable by the computing system to generate the neural network such that the topology includes a layer corresponding to each of the two or more input graphical plots.

4. The medium of claim 1, wherein the instructions are executable by the computing system such that the determined one or more characteristics correspond to types of the set of input graphical plots.

5. The medium of claim 1, wherein the instructions are executable by the computing system such that the determined one or more characteristics correspond to a number of the set of input graphical plots.

6. The medium of claim 1, wherein the instructions are executable by the computing system such that the determined one or more characteristics correspond to a data source corresponding to each of the one or more input graphical plots.

7. The medium of claim 1, wherein, in response to two or more input graphical plots being selected, the instructions are executable by the computing system such that the determined one or more characteristics correspond to a sequence of the one or more input graphical plots.

8. The medium of claim 1, wherein the instructions are executable by the computing system to:
generate a plurality of preliminary neural networks based on different sequences of the set of input graphical plots;
select one of the plurality of preliminary neural networks as the neural network.

9. The medium of claim 8, wherein selection of the neural network from the plurality of preliminary neural networks is based on a metric, wherein the metric measures one or more of: complexity of the neural network, performance of the neural network, or quality of results returned from the neural network.

10. The medium of claim 1, wherein the instructions are executable by the computing system such that the determined one or more characteristics correspond to a frequency with which data variables are repeated in the set of input graphical plots.

11. A method comprising:
receiving, at a computer system, an indication of a set of one or more input graphical plots selected from one or more graphical plots displayed via a dashboard user interface;
determining, by the computer system, one or more characteristics of the set of input graphical plots;
generating, by the computer system, a neural network having a topology based on the determined one or more characteristics;
training, by the computer system, the neural network using a set of training data;
subsequently processing, by the computer system, input data using the neural network; and
sending, by the computer system, information usable to display results of the processing as a set of one or more output graphical plots.

12. The method of claim 11, wherein the computer system includes a server computer system and a client computer system, wherein the neural network is generated by the server computer system, and wherein the sending includes sending the information usable to display results of the processing from the server computer system to the client computer system for display.

13. The method of claim 11, wherein the computer system is an end-user computer system, and wherein the sending includes sending the information usable to display results of the processing to a display device of the end-user computer system.

14. The method of claim 11, wherein the set of input graphical plots includes two or more graphical plots, and wherein the generating includes producing a neural network such that the topology includes a layer corresponding to each of the input graphical plots.

15. The method of claim 11, wherein the set of input graphical plots includes two or more graphical plots, and wherein the determined one or more characteristics correspond to a sequence of the set of input graphical plots.

16. The method of claim 11, wherein the generating includes producing a plurality of preliminary neural networks based on different sequences of the set of input graphical plots and selecting, by the computing system, one of the plurality of preliminary neural networks as the neural network.

17. A non-transitory computer-readable storage medium having instructions stored thereon that are executable by a computing system to perform operations comprising:
sending information usable to display a dashboard user interface, wherein the dashboard user interface includes one or more graphical plots;
determining one or more characteristics of a set of one or more input graphical plots selected from the one or more graphical plots;
communicating the determined one or more characteristics to a neural network generation module operable to generate and train a neural network based on the determined one or more characteristics;
receiving information from a neural network module indicative of results of processing input data using the neural network;
sending information usable to display, as a set of one or more output graphical plots via the dashboard user interface, results of processing the input data.

18. The medium of claim 17, wherein the neural network module is maintained by a server computing system distinct from the computing system.

19. The medium of claim 17, wherein the computer system is an end-user computing system, and wherein the sending includes sending the information usable to display results of the processing to a display device of the end-user computing system.

20. The medium of claim 17, further comprising communicating data for training the neural network to the neural network generation module.
